(19) United States
(12) Patent Application Publication
(10) Pub. No.: US 2005/0201416 A1
(43) Pub. Date: Sep. 15, 2005

(54) Transmitter and receiver for data burst in a wireless communication system

(75) Inventors: Sun-Ny Chang, Suwon-si (KR); Yun-Sang Park, Suwon-si (KR); Tae-In Hyon, Hwaseong-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/076,608

(22) Filed: Mar. 10, 2005

(30) Foreign Application Priority Data
Mar. 12, 2004 (KR) 17101/2004

(51) Int. Cl. H04J 3/22

(52) U.S. Cl. 370/469

(57) ABSTRACT

An apparatus and method for separating data units from a received concatenated burst in a wireless communication system, and an apparatus and method for generating a concatenated data unit during transmission. If a reception end receives the burst, it determines if each data of the burst is a header of the data unit, such that it can separate the data unit from the burst. A transmission end designates individual starting points of data units to be equal to an integer multiple position of a predetermined size, and constructs a concatenated format of the data units, such that it generates the burst.

### PRIORITY

This application claims priority to an application entitled “METHOD AND APPARATUS FOR RECEIVING SUCCESSIVE DATA UNIT IN WIRELESS COMMUNICATION SYSTEM, METHOD AND APPARATUS FOR TRANSMITTING DATA UNIT FOR TRANSMISSION, AND ASSOCIATED DATA BURST STRUCTURE”, filed in the Korean Intellectual Property Office on Mar. 12, 2004 and assigned Serial No. 2004-17101, the contents of which are hereby incorporated by reference.

### BACKGROUND OF THE INVENTION

1. Field of the Invention

The present invention relates generally to a data communication system in a wireless communication system, and more particularly to an apparatus and method for separating data units from a burst when a plurality of data units (e.g., Protocol Data Units (PDUs)) receives a successive burst, an apparatus and method for generating a concatenated data unit for transmission, and an associated data burst structure.

2. Description of the Related Art

A wireless communication system, particularly, a broadband wireless communication system is mainly comprised of three layers. The first layer is a physical layer for wireless transmission. The second layer includes an RLC (Radio Link Control) layer for transmitting reliable data and a MAC (Media Access Control) layer for effectively providing a plurality of services at the same time. The third layer includes a CC (Call Control) layer for establishing/canceling a call connection state, an MM (Mobility Management) layer for authenticating/registering a service user, and an RRC (Radio Resource Control) layer for assigning/managing radio resources.

The MAC layer for data transmission/reception converts a logical channel of the RLC layer into a transport channel, such that it transmits the transport channel data to a lower layer. Alternatively, the MAC layer converts the transport channel into the logical channel, and transmits the logical channel data to an upper layer. The MAC layer includes a MAC-c/sh module for transmitting/receiving a common/shared transport channel and a MAC-d module for transmitting/receiving a dedicated transport channel. A logical channel of the RLC layer is mapping-processed with a transport channel of the MAC layer during data transmission, and the MAC layer further includes a TFC selection module for adjusting the magnitude of transmission/reception data.

The RLC layer divides or integrates data received from the upper layer, and transmits the resultant data to the MAC layer over the logical channel. The RLC layer is divided into a TM (Transport Mode), an UM (Unacknowledged Mode), and an AM (Acknowledged Mode). The RLC layer stores data received from the upper layer in a transport buffer according to individual modes, divides or integrates the data stored in the transport buffer by the size of a PDU (Protocol Data Unit) and the number of blocks, and transmits the divided or integrated result to the MAC layer.

A transmission end in the broadband wireless communication system configures a plurality of MAC PDUs as a single burst, and successively transmits the burst over a physical layer. Thereafter, a reception end in the broadband wireless communication system separates individual PDUs from the single burst.

However, the transmission end is unable to recognize the number of PDUs concatenated in the single burst and the size of each PDU. Therefore, the reception end reads a beginning header to recognize the size of each PDU, and separate the PDUs from the burst. The reception end designates data generated after the separation of the PDU as a new PDU's header, and recognizes the size of new PDU in the determined header, such that it separates the PDU from the burst. Accordingly, if there is an error in the header of the preceding concatenated PDU, it is impossible for a following PDU next to the preceding PDU to be separated from the burst, such that the preceding and following PDUs must be abandoned.

FIG. 1 is a diagram illustrating a burst configuration for use in a conventional wireless communication system. More specifically, a transmission end for use in the conventional broadband wireless communication system successively transmits a variety of PDUs 10 through 40 formed by several connected terminals according to the size of a burst 50 assigned by a specification. The MAC PDU of the conventional system can be configured in various sizes (e.g., various sizes from a bandwidth request header of 48 bits to a PDU length field of 2048 bits), such that the next MAC header is able to begin at all the positions.

Referring to FIG. 1, the PDU 10 includes a MAC header 12 and a payload part 14. The MAC header 12 includes information associated to the PDU size, but individual PDUs have different PDU sizes. A reception end recognizes the size of payload part 14 by referring to the above PDU size. The payload part 14 includes CRC information to determine the presence or absence of an error.

FIG. 2 is a flow chart illustrating a method for separating the PDUs from the burst in the conventional wireless communication system. Referring to FIGS. 1 and 2, the reception end reads data identifying the size of the MAC header at a beginning part of a received burst 50 at step 102. More specifically, the reception end reads an initial 6 bytes of the burst 50. As illustrated in FIG. 1, the four PDUs 10 through 40 are concatenated with the single burst 50. The reception end reads the initial 6 bytes 12 from the burst 50. The initial data is a header 12 of a MAC PDU, from which the reception end determines whether the header is valid using an HCS (Header Check Sequence) at step 104. The reception end determines if the header is equal to the valid header at step 106. More specifically, the reception end determines if data equal to a corresponding header passes the HCS check procedure at step 106. If the data is valid data, the reception end determines if a corresponding header is a bandwidth request header at step 108. The bandwidth request header requests a desired bandwidth from a wireless communication system, and is not accompanied with a payload part. Therefore, if the corresponding header is the bandwidth request header, there is no successive payload part, such that data following the corresponding header may also be the header part. Therefore, if the corresponding header is determined to be the bandwidth request header, the reception end returns to step 102, such that it re-reads data equal to the size of the MAC header.

If the corresponding header is not the bandwidth request header, the reception end separates the first MAC PDU 10 using payload size information included in the header at step 110. More specifically, although the reception end does not know the size of the concatenated MAC PDUs, it can recognize the size of the MAC PDUs by reading the MAC header.

The reception end performs a CRC check process to determine if there is a payload error at step 112. If a corresponding PDU passes the CRC check process, the reception end determines the corresponding PDU to be a valid PDU at step 114, and decrypts the corresponding PDU at step 118. However, if the corresponding PDU does not pass the CRC check process, the reception end discards the corresponding PDU at step 116, and returns to step 102.

The reception end separates the first MAC PDU from the burst, and then determines the presence or absence of the next data. If the presence of the next data is determined at step 120, the reception end returns to step 102, such that it determines data of 6 bytes to be the MAC header, and reads the data of 6 bytes as the MAC header. The reception end determines the presence or absence of effectiveness of the MAC header in the same manner as in the aforementioned case for separating the first PDU from the burst, and separates the second PDU from the burst by referring to the size of PDU contained in the MAC header. In this manner, a number of concatenated PDUs can be separated from the burst.

The reception end determines if data recognized as a corresponding header passes the HCS check procedure, in order to determine if the corresponding header is a valid header at step 106. If the corresponding header is not a valid header at step 106, the reception ends discards a corresponding burst at step 107.

Although there is an error in the payload part when the reception end separates the PDU from the burst, this error causes no problem. However, if there is an error in the MAC header, it is impossible to recognize the size of a corresponding MAC PDU. As a result, PDUs following the erroneous MAC header cannot be separated from the burst, such that a PDU following the MAC header is also unable to be separated from the burst, and the next PDU after that PDU is also unable to be separated, etc., such that all the following PDUs must be discarded.

### SUMMARY OF THE INVENTION

It is an aspect of the present invention to provide an apparatus and method for correctly separating concatenated valid data from a burst without discarding the concatenated valid data even when there is an error in a PDU header of the burst.

It is another aspect of the present invention to provide an apparatus and method for generating a burst of a transmission end such that a reception end searches for a MAC header position and effectively separates a valid data packet from the burst.

It is yet another aspect of the present invention to provide a transmission burst data structure including concatenated data units.

In accordance with at least one aspect of the present invention, a method for receiving concatenated data units from a received burst in a wireless communication system is provided. The method includes the steps of: searching for a starting point of a predetermined header from the received burst; determining if data corresponding to the searched starting point is a header; and separating a corresponding PDU (Protocol Data Unit) from the burst according to the determined result.

In accordance with another aspect of the present invention, there is provided an apparatus for receiving concatenated data units from a received burst in a wireless communication system. The apparatus includes: a data unit separator for searching for a starting point of a predetermined header from the received burst, determining if data corresponding to the searched starting point is indicative of a header, and separating a corresponding PDU (Protocol Data Unit) from the burst according to the determined result.

In accordance with another aspect of the present invention, there is provided a method for generating a burst using concatenated data units of a transmission end, and transmitting the burst. The method includes the step of: designating a starting point of each data unit to begin at a specific position corresponding to an integer multiple of a predetermined size in the burst when at least two data units are concatenated to each other.

In accordance with another aspect of the present invention, there is provided an apparatus for generating a burst using concatenated data units of a transmission end, and transmitting the burst. The apparatus includes a data unit mapper for designating a starting point of each data unit to begin at a specific position corresponding to an integer multiple of a predetermined size in the burst when at least two data units are concatenated to each other.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating a burst configuration for use in a conventional wireless communication system;

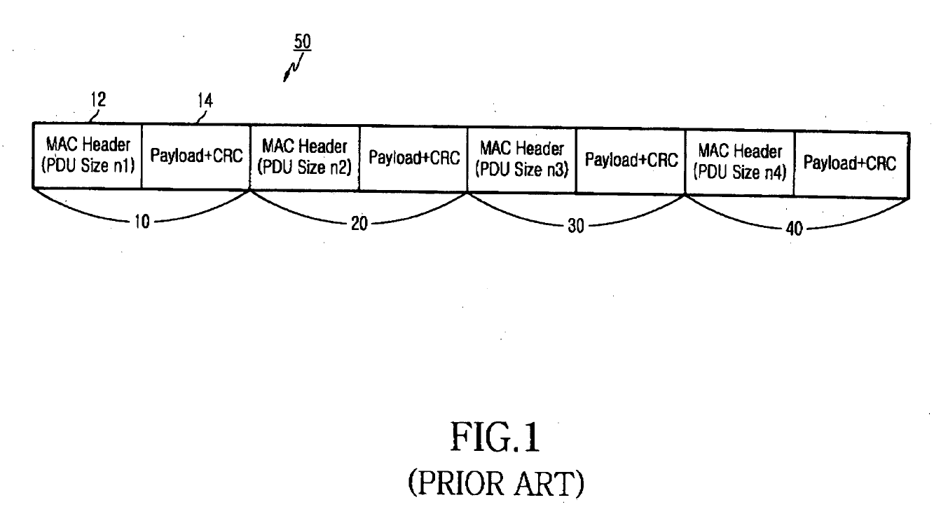

FIG. 2 is a flow chart illustrating a method for separating a data unit from a burst in the conventional wireless communication system;

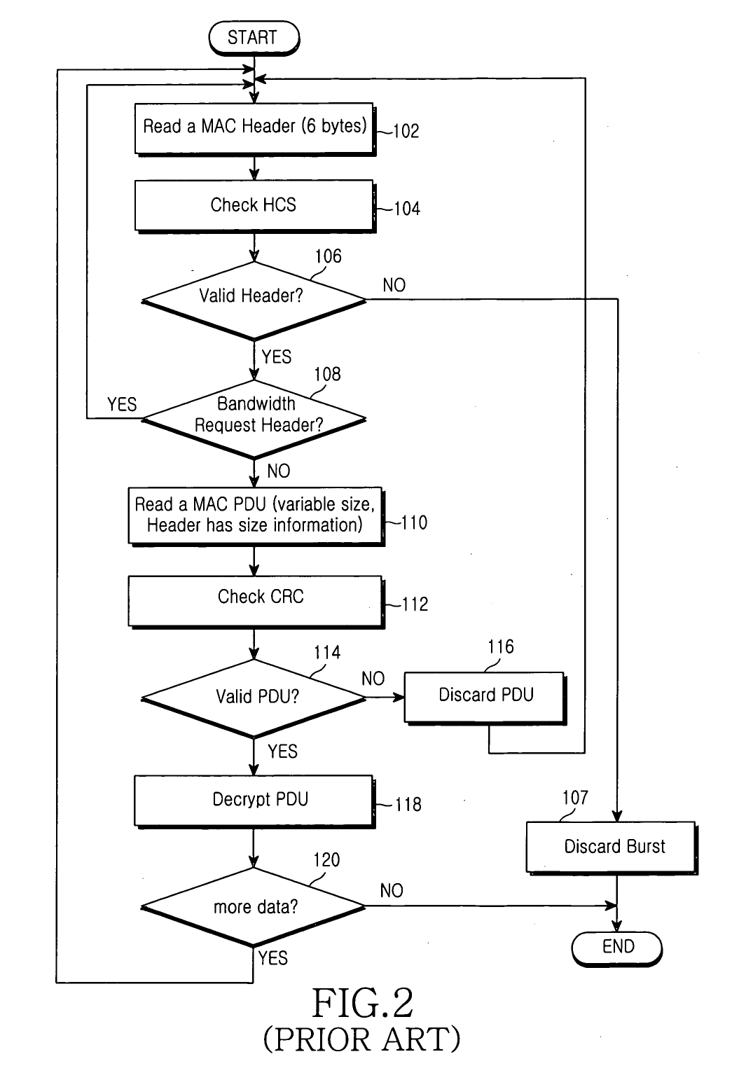

FIG. 3A is a diagram illustrating a MAC header structure;

FIG. 3B is a diagram illustrating a bandwidth request header structure;

FIG. 4 is a flow chart illustrating a method for separating a data unit from a received burst in accordance with a preferred embodiment of the present invention;

FIG. 5 is a block diagram illustrating an apparatus for separating a data unit from a received burst in accordance with a preferred embodiment of the present invention;

FIG. 6 is a diagram illustrating a data burst structure in accordance with a preferred embodiment of the present invention;

FIG. 7 is a flow chart illustrating a method for separating a transmission burst using a concatenated data unit in accordance with a preferred embodiment of the present invention; and

FIG. 8 is a block diagram illustrating a transmission burst using a concatenated data unit in accordance with a preferred embodiment of the present invention.

### DETAILED DESCRIPTION OF THE PREFERRED EMBODIMENTS

Preferred embodiments of the present invention will be described in detail herein below with reference to the annexed drawings. In the drawings, the same or similar elements are denoted by the same reference numerals even though they are depicted in different drawings. Additionally, in the following description, a detailed description of known functions and configurations incorporated herein will be omitted when it may obscure the subject matter of the present invention.

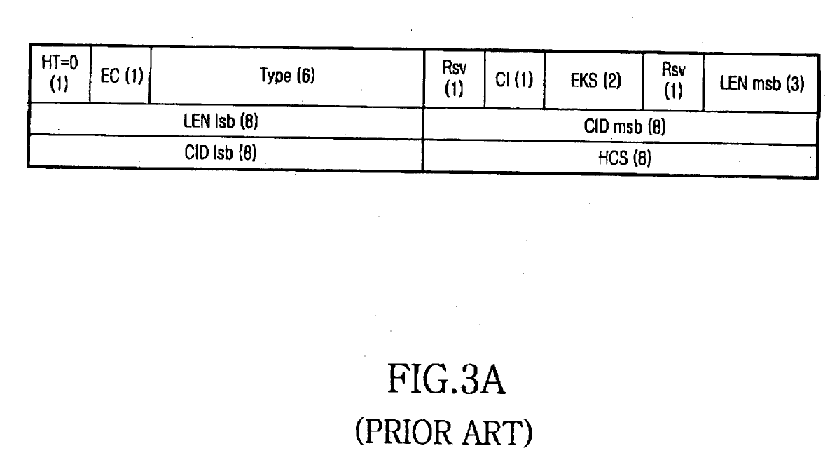

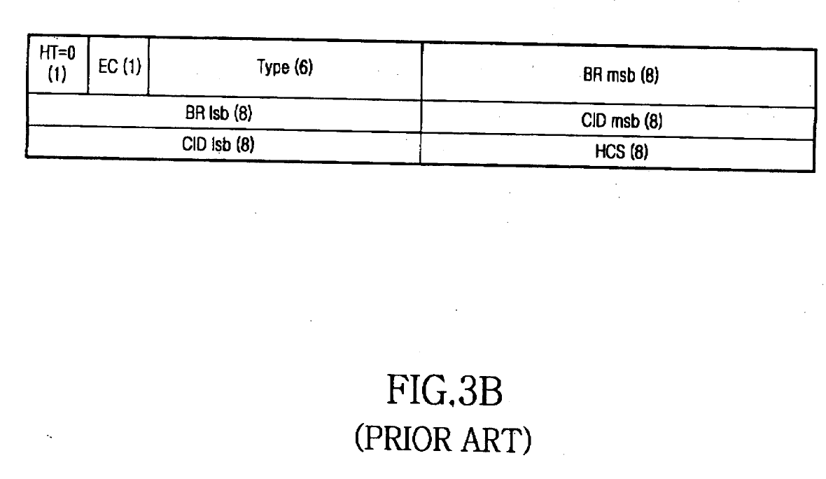

For the convenience of description and better understanding of the present invention, a MAC header structure and a bandwidth request header structure will be described in detail herein below with reference to FIGS. 3A and 3B. More specifically, FIG. 3A is a diagram illustrating a MAC header structure. FIG. 3B is a diagram illustrating a bandwidth request header structure.

Referring to FIGS. 3A and 3B, the MAC header and bandwidth request header are distinguished from each other by an HT (Header Type) field. If the HT field is set to ‘1’, a corresponding MAC header is used for the bandwidth request packet. The corresponding MAC is a special packet, which does not include a payload part, i.e., it only includes a header. If the HT is set to ‘0’, the MAC header is used for a typical packet receiving a payload.

As indicated above, if there is an error in the MAC PDU header, the present invention discards only a corresponding PDU from among concatenated PDUs, and searches for a header starting position of the MAC PDU concatenated with the erroneous PDU. For example, a predetermined size (a MAC PDU size or its multiple size) can be 8 bits, 16 bits, 24 bits, 32 bits, 48 bits, etc., and it is described in the following embodiment to set 48 bits as the predetermined size and to search for a next MAC header with an integer multiple of 48 bits. That is, the following embodiments will be described as a MAC PDU size having 48 bits, although the present invention is not limited to this Mac PDU size. For example, the MAC PDU size can be 8 bits, 16 bits, 24 bits, 32 bits, 48 bits, and its multiple size. Also, a MAC Header has the same size as the MAC PDU.

It is also possible that if there is an error in the MAC header, all of the PDUs are not necessarily discarded, but a next MAC header having no error is searched per a predetermined size so as to demodulate the corresponding PDU. That is, in order to receive a burst having a plurality of MAC PDUs and demodulate the same, a MAC Header should be firstly searched and the MAC Header has the same size as the MAC PDU or its multiple. Thus, in order to find a start point of the MAC header, it is searched per a predetermined size or the multiple thereof.

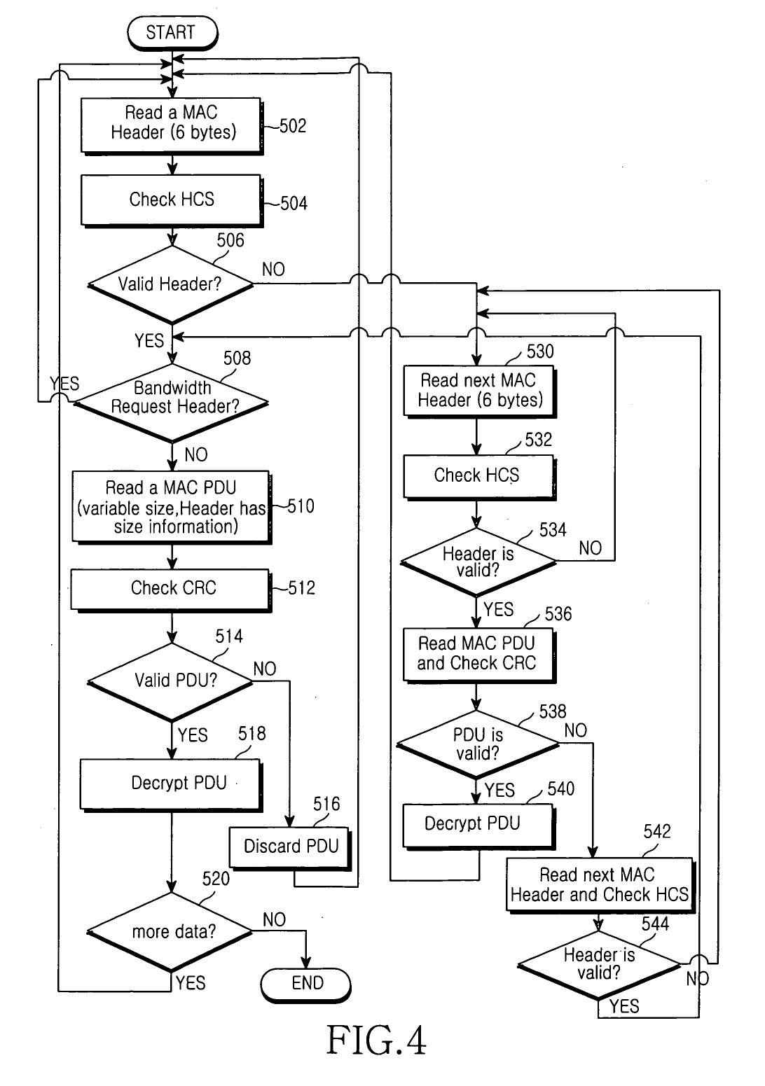

FIG. 4 is a flow chart illustrating a method for separating a data unit such as a PDU from a received burst in accordance with a preferred embodiment of the present invention. Referring to FIG. 4, a reception end reads data indicating the size of the MAC header at a beginning part of a received burst at step 502. More specifically, the reception end reads an initial 6 bytes of the burst. As indicated above, the initial data indicates a header of a MAC PDU, such that the reception end can determine if the header is valid using an HCS (Header Check Sequence) at step 504. The reception end determines if the header is valid at step 506. More specifically, the reception end determines if data included in the header passes the HCS check procedure at step 506. If the data is valid, the reception end separates the initial MAC PDU using payload size information included in the header at step 510.

In accordance with a more preferred embodiment of the present invention, the present invention may further perform step 508 after performing the above step 506. That is, if the reception end determines that the header is valid at step 506, it determines if the header is a bandwidth request header at step 508.

As can be seen from FIGS. 3A and 3B, the MAC header and bandwidth request header are distinguished from each other on the basis of the HT field. If the HT field is set to ‘1’, a corresponding MAC header is used for the bandwidth request packet. The corresponding MAC is a special packet, which does not include a payload part, i.e., it only includes a header. If the HT is set to ‘0’, the MAC header is used for a typical packet receiving a payload.

Therefore, there is no concatenated payload when the header is determined to be the bandwidth request header, such that the next data may also be part of the header. If the header is the bandwidth request header, the reception end returns to step 502, and re-reads data equal to the size of the MAC header at step 502. However, if the header is not a bandwidth request header, the reception end separates the initial MAC PDU from the burst using payload size information included in the header at step 510.

Accordingly, while the reception end does not know the size of the concatenated MAC PDUs, it can recognize the size of the MAC PDUs by reading the MAC header.

At step 512, the reception end performs a CRC check process to determine if there is a payload error. If a corresponding PDU passes the CRC check process, the reception end determines that the corresponding PDU is valid at step 514, and decrypts the corresponding PDU at step 518. However, if the corresponding PDU does not pass the CRC check process at step 514, the reception end discards the corresponding PDU at step 516, and returns to step 502.

The reception end separates the first MAC PDU from the burst, and then determines if there is more data at step 520. If there is more data, the reception end returns to step 502 and determines data of 48 bits to be the MAC header, and reads the data of 48 bits as the MAC header. The reception end determines the effectiveness of the MAC header in the same manner as in the aforementioned case for separating the first PDU from the burst, and separates the second PDU from the burst by referring to the size of PDU contained in the MAC header. Accordingly, a number of concatenated PDUs can be separated from the burst.

The reception end determines if data recognized as a corresponding header passes the HCS check procedure. That is, if the corresponding header is not a valid header at step 506, the reception ends re-reads the data of the next 48 bits as the header size at step 530. The reception end determines that the first 48 bits of a corresponding burst is not the header, such that it re-reads the data of the next 48 bits to determine if the data of 48 bits is the header. That is, if the data fails to pass the HCS check procedure, data of 48 bits are read from a point enabling the next MAC PDU to start. The reception end determines if the read header is effective by performing an HCS check at step 532. Thereafter, the reception ends determines if the header is effective at step 534. More specifically, the reception ends determines if data recognized as the corresponding header passes the HCS check procedure at step 534.

If the data recognized as the corresponding header is valid, the reception end separates the MAC PDU from the burst using the payload size information contained in the header at step 536. In this case, the reception end can determine whether the payload size is an integer multiple of 48 bits by referring to a LEN field of the MAC header. If the payload size is not equal to the integer multiple of 48 bits, the corresponding header is an ineffective header.

If the beginning bit is set to ‘1’, i.e., if a corresponding header is a bandwidth request header, the reception end determines if bits from the second bit to the seventh bit (i.e., the five bits positioned at the front of EC and TYPE fields) are each equal to ‘0’. Accordingly, the reception end can correctly check that the corresponding header is a bandwidth request header.

The reception end performs the CRC check process to determine any payload errors at step 536. If the corresponding header passes the CRC check process at step 538, the reception end determines that data having been recognized as header data at step 530 is equal to real data at step 538, and decrypts the corresponding PDU at step 540. If the corresponding PDU does not satisfy the CRC check process, the reception end determines data of concatenated 48 bits after the read PDU of step 536 to be a MAC header of the next PDU, reads the determined MAC header of the next PDU, and determines if the HCS check process is satisfied at step 542, such that it can re-determine if the data having been read as the header at the above step 530 is incorrectly determined as the real header, or a unexpected error occurs in real data even though the real data has been found at the above step 530.

The reception end determines whether the header is valid using the HCS at step 544. If the header is valid at step 544, the reception end determines that a real header has been found at the above step 530, and returns to step 510. However, if the header is not valid at step 544, the reception end determines that data recognized as the header at the above step 530 is incorrectly determined to be the header, and returns to step 530 to re-search for the header. Therefore, if the header is not valid, the reception end reads data identifying the header size at step 530, and proceeds to step 532.

If there is an error in the MAC PDU header, the present invention discards only a corresponding PDU from among concatenated PDUs of the burst, and searches for a header starting position of the MAC PDU concatenated with the erroneous PDU.

The reception end discards the PDU when an error occurs in the PDU header during a PDU separation process, discards the erroneous PDU, searches for a starting point of the next PDU header, and separates the MAC PDU. For this purpose, there must be a method for searching for the starting point of the next MAC header. For example, the HCS check method for the MAC header and the other CRC check method for the MAC PDU are properly adapted to search for a starting point of the MAC header in the present invention.

A method for searching for a starting point of a next MAC header when the error occurs in the MAC header will hereinafter be described.

1) The method reads data of 48 bits from a specific position, which will be equal to a starting position of the next MAC header, when generating an error in the MAC header.

2) The method considers data to be a MAC header when the data satisfies the HCS check process, and reads PDU size information contained in the MAC header.

3) The method performs the CRC check process by reading the MAC PDU, and performs the HCS check process by reading 48 bits positioned at the next MAC header position.

4) If one of the CRC check process and the HCS check process is satisfied, it is determined that a starting position of the correct MAC header has been found, and a PDU separation process begins. If the CRC check process and the HCS check process are not satisfied, the method returns to step 1), reads data of 48 bits from a specific position which will be equal to a starting position of the MAC header, and repeats the steps 2)-3).

Although the aforementioned preferred embodiment has disclosed a case in which the header size is equal to 48 bits, it should be noted that the scope and spirit of the invention is not limited to the aforementioned case.

If a header size to be checked from a predetermined start position usable as a header is processed by the HCS check and satisfies the HCS check, it is determined to be a starting position of the MAC header, such that the header is separated from the burst.

When the header satisfies the HCS check after the header size to be checked at a predetermined position is processed by the HCS check, a PDU size is read from the header, and a CRC check process is applied to data equal to a corresponding PDU size. In this case, if the data satisfies the CRC check process, the data is determined to be a starting position of the MAC header, such that separation of the header is performed.

Preferably, if the header satisfies the HCS check after the header size to be checked at a first starting position is processed by the HCS check, a PDU size is read from the header, and a CRC check process is applied to data equal to a corresponding PDU size. In this case, although the data does not satisfy the CRC check process, a header size from a second starting position next to the first starting position is read, and the HCS check process is used to the read header size. In this case, if the read header size satisfies the HCS check process, the second starting position is determined to be a starting position of the MAC header, such that separation of PDU is then performed.

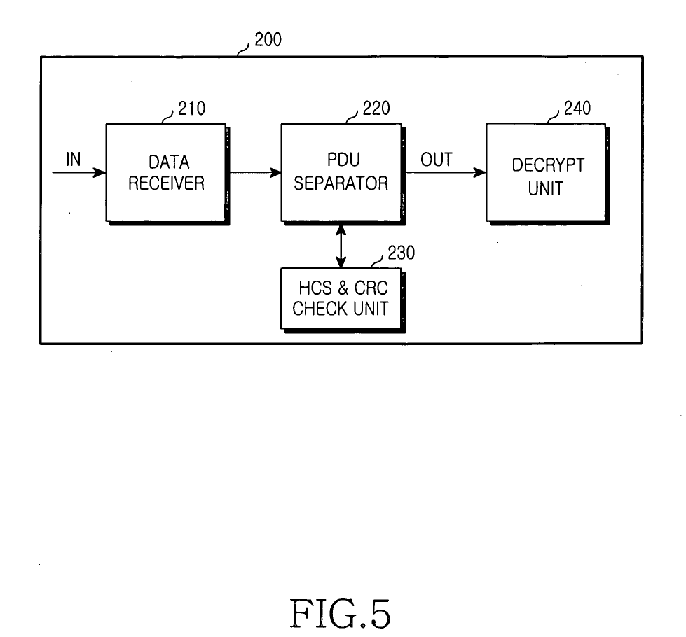

FIG. 5 is a block diagram illustrating a receiver for separating a data unit from a received burst in accordance with a preferred embodiment of the present invention. Referring to FIG. 5, the receiver 200 includes a data receiver 210, a PDU separator 220, an HCS & CRC check unit 230, and a decryption unit 240.

The data receiver 210 receives burst data from a transmission end. The burst data is a data stream configured in the form of concatenated PDUs. The data receiver 210 provides the PDU separator 220 with the received burst data. Upon receiving the burst data from the data receiver 210, the PDU separator 220 processes the burst according to the flow chart illustrated in FIG. 4. More specifically, the PDU separator determines if each data identifying the burst data size is a header of a data unit, such that it can separate the data unit from the burst. Otherwise, the PDU separator 220 determines if each data is the data unit header at a predetermined position of the burst data, such that it can separate the data unit from the burst. The separated data unit is transferred from the PDU separator 220 to the decryption unit 240. The HCS & CRC check unit 230 performs an HCS check process or a CRC check process upon receiving predetermined data from the PDU separator 220, and informs the PDU separator 220 of the process result. The decryption unit 240 decrypts encrypted PDUs received from the PDU separator 220.

A position of the next concatenated MAC header may begin at all positions of a system with a variable PDU size. If the HCS check and the CRC check are performed to search for the MAC header at all positions when the MAC PDU is separated in the system of the variable PDU size in the same manner as illustrated in FIG. 4, processing complexity may be largely increased.

When the transmission end performs concatenation of the MAC PDUs, the present invention limits individual starting positions of the MAC PDUs to an integer multiple of a minimum data unit size (e.g., an integer multiple of a minimum PDU size, or an integer multiple of a minimum header size) in the burst.

Therefore, the present invention does not increase the processing complexity of the reception end, does not discard total data when there is an error in the header, and provides a method and apparatus for correctly separating a rear concatenated header or a data unit such as a PDU.

For example, if an original PDU size is an integer multiple of 48 bits when the minimum PDU size is equal to 48 bits, the present invention uses the PDU without any change. If the PDU is determined to be a MAC PDU, which is unable to be fragmented or packed, the PDU size may be different from the integer multiple of 48 bits, such that an unexpected gap may occur in the end of the MAC PDU and the starting position of the next MAC header. In this case, a padding process may be performed by a zero-padding process or a parameter ‘1’.

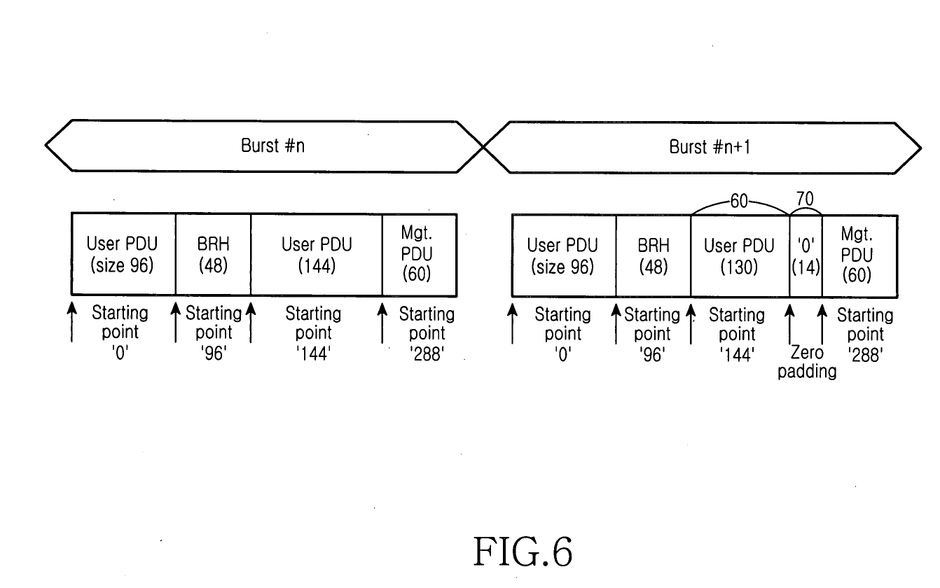

FIG. 6 is a diagram illustrating a data burst structure in accordance with a preferred embodiment of the present invention. Referring to FIG. 6, a plurality of PDUs are concatenated in each burst (e.g., Burst #N and Burst #N+1). The MAC header of each PDU contained in the burst is determined to be an integer multiple of a predetermined bit number of each burst. For example, as illustrated in FIG. 6, a starting point of the MAC header of each PDU is determined to be an integer multiple of 48 bits.

In the burst (Burst #N) in FIG. 6, a starting point of each PDU is determined to be an integer multiple of 48 bits. However, in the burst (Burst #N+1), the size of user data 60 is equal to 130 bits, such that the user data 60 is not configured with the size of the integer multiple of 48 bits. Therefore, the padding process is performed using a parameter ‘0’or ‘1’ in order to allow the size of user data 60 to be an integer multiple of 48 bits. In the burst (Burst #N+1), a padding field 70 is positioned between the end of the MAC PDU 130 and the starting point of the next MAC header. Otherwise, in the burst (Burst #N+1), a specific bit is padding-processed between the end of the MAC PDU 130 and the starting point of the next MAC header.

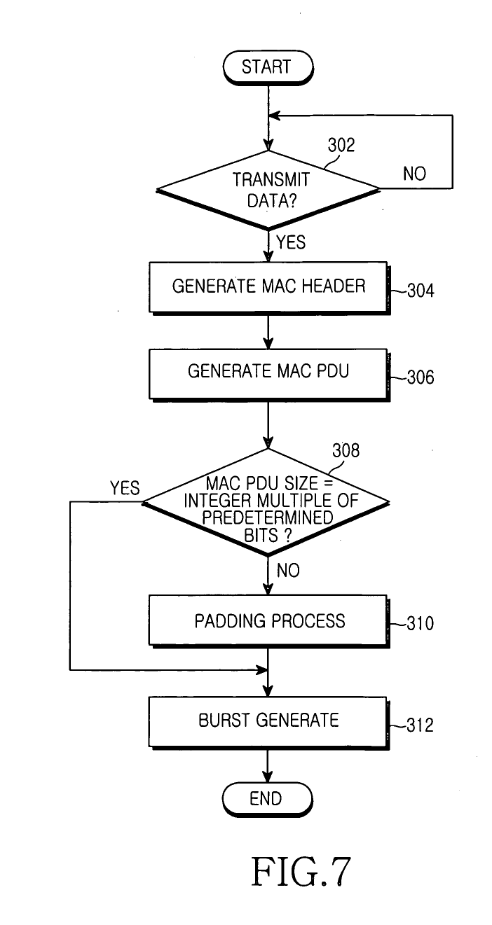

FIG. 7 is a flow chart illustrating a method for separating a transmission burst using a concatenated data unit in accordance with a preferred embodiment of the present invention. Referring to FIG. 7, a transmission end determines if data is to be transmitted at step 302. More specifically, the transmission end determines if data is transmitted upon receiving a data transmission request from at least one MS (Mobile Station) at step 302. If the presence of the data to be transmitted is determined at step 302, the transmission end generates a MAC header of corresponding transmission data at step 304, and combines the MAC header with a payload such that it generates a MAC PDU at step 306. If a MAC header having no payload is determined, the transmission end generates the MAC PDU using only the MAC header.

The transmission determines if the MAC PDU size to be transmitted is an integer multiple of a predetermined bit number at step 308. If the MAC PDU size is determined to be the integer multiple of predetermined bit number, the transmission end proceeds to step 312. If the MAC PDU size to be transmitted is not equal to the integer multiple of predetermined bit number, the transmission end performs the padding process in step 310, using a specific parameter ‘0’ or ‘1’ in order to allow the MAC PDU size to be equal to the integer multiple of predetermined bit number. Accordingly, the MAC PDU to be transmitted can have a predetermined size equal to the integer multiple of predetermined bit number.

The transmission end provides a concatenated format of data units each equal to the size of integer multiple of predetermined bit number, such that it generates a burst.

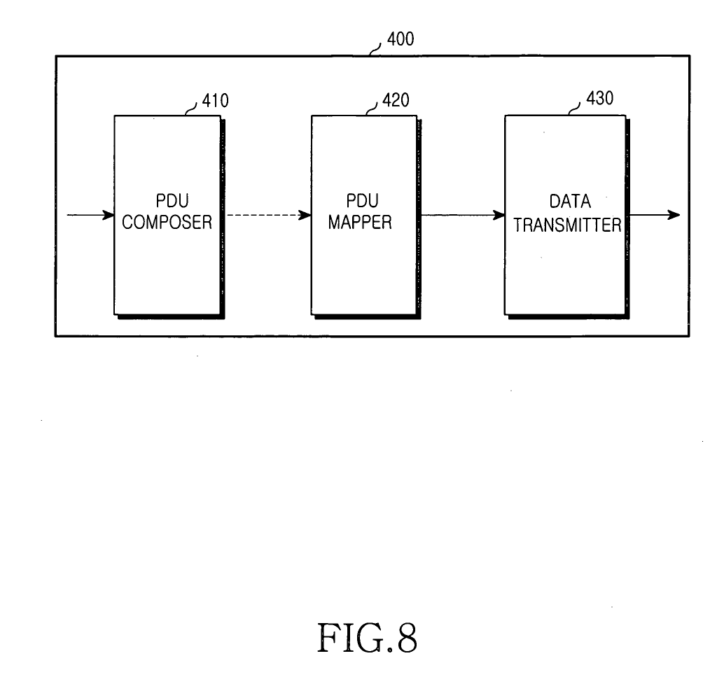

FIG. 8 is a block diagram illustrating a transmission burst using a concatenated data unit in accordance with a preferred embodiment of the present invention. Referring to FIG. 8, the transmitter 400 includes a PDU composer 410, a PDU mapper 420, and a data transmitter 430. If data to be transmitted is determined, the PDU composer 410 combines the MAC header with a payload, such that it generates a MAC PDU. If the MAC header having no payload is determined, the PDU composer generates the MAC PDU using only the MAC header. In this case, if a special PDU unable to be packed or fragmented is determined, the PDU size is not determined to be the integer multiple of a predetermined size. The PDU composer 410 transmits the generated PDU to the PDU mapper 420.

The PDU mapper 410 determines if the size of the MAC PDU to be transmitted is equal to an integer multiple of a predetermined bit number. If the size of the MAC PDU to be transmitted is not equal to the integer multiple of predetermined bit number, the PDU composer 410 performs the padding process using a specific parameter ‘0’ or ‘1’ in order to allow the PDU size to be equal to the integer multiple of predetermined bit number. The PDU mapper 420 provides a concatenated format of data units each equal to the size of integer multiple of predetermined bit number, such that it generates the burst.

More specifically, the PDU mapper 410 generates a burst by concatenating at least PDUs in order to allow a starting point of the MAC PDU header to be equal to a position of an integer multiple of 48 bits, and transmits the generated burst to the data transmitter 430. If an unexpected gap is generated between the end of the MAC PDU and the starting point of the next MAC header located at the position of the integer multiple of 48 bits, the gap is filled with a specific value, e.g., ‘0’ or ‘1’. The data transmitter 430 transmits the burst.

As is apparent from the above description, the present invention improves the conventional method for unavoidably determining all the PDUs to be erroneous PDUs because it is unable to separate all the PDUs from a burst when an error occurs in a header of any PDU during transmission of the burst composed of concatenated PDUs, such that the present invention is able to separate the remaining PDUs even though an error occurs in one PDU, resulting in an increased frame error rate.

Although the preferred embodiments of the present invention have been disclosed for illustrative purposes, those skilled in the art will appreciate that various modifications, additions, and substitutions are possible, without departing from the scope and spirit of the present invention as disclosed in the accompanying claims.

1. A method for receiving concatenated data units from a received burst in a wireless communication system, comprising the steps of:
searching for a starting point of a predetermined header from the received burst;
determining if data corresponding to the searched starting point is a header; and
separating a corresponding PDU (Protocol Data Unit) from the burst according to the determined result.

2. The method according to claim 1, wherein the step of determining if the data corresponding to the searched starting point is the header comprises the step of:
determining if a current format satisfies a predetermined format of the header.

3. The method according to claim 1, wherein the step of determining if the data corresponding to the searched starting point is the header comprises the step of:
reducing complexity by performing an HCS (Header Check Sequence) check process.

4. The method according to claim 1, wherein the step of determining if the data corresponding to the searched starting point is the header comprises the steps of:
checking an HCS (Header Check Sequence), reading a payload using a header satisfying an HCS check process, and performing a CRC (Cyclic Redundancy Check) process.

5. The method according to claim 1, wherein the step of determining if the data corresponding to the searched starting point is the header comprises the steps of:
checking an HCS (Header Check Sequence), reading a payload using a header satisfying an HCS check process, performing a CRC (Cyclic Redundancy Check) process, reading a header of a next PDU, combining HCS check results, and determining if the data is the header.

6. The method according to claim 1, further comprising the step of:
determining if the determined header is one of a MAC (Media Access Control) header and a bandwidth request header, if the data is determined to be the header of the PDU.

7. The method according to claim 1, further comprising the step of:
if the header of the PDU is a general MAC header, separating the PDU from the burst according to payload size information contained in the MAC header.

8. The method according to claim 1, further comprising the step of:
if the header of the PDU is a bandwidth request header, determining re-concatenated data to be a header of the PDU.

9. An apparatus for receiving concatenated data units from a received burst in a wireless communication system, comprising:
a data unit separator for searching for a starting point of a predetermined header from the received burst, determining if data corresponding to the searched starting point is a header, and separating a corresponding PDU (Protocol Data Unit) from the burst according to the determined result.

10. The apparatus according to claim 9, wherein the data unit separator determines if a current format satisfies a predetermined format of the header such that it can determine if the data is the header.

11. The apparatus according to claim 9, wherein the data unit separator performs an HCS (Header Check Sequence) check to determine if the data is the header.

12. The apparatus according to claim 9, wherein the data unit separator checks an HCS (Header Check Sequence), reads a payload using a header satisfying an HCS check process, and performs a CRC (Cyclic Redundancy Check) process, in order to determine if the data is the header.

13. The apparatus according to claim 9, wherein the data unit separator checks an HCS (Header Check Sequence), reads a payload using a header satisfying an HCS check process, performs a CRC (Cyclic Redundancy Check) process, reads a header of a next PDU, and combines HCS check results, in order to determine if the data is the header.

14. The apparatus according to claim 13, further comprising:
an HCS & CRC check unit for checking the HCS, and performing the CRC process.

15. The apparatus according to claim 9, wherein the data unit separator determines if a header of the PDU is one of a MAC (Media Access Control) header and a bandwidth request header when the data is determined to be the header of the PDU.

16. The apparatus according to claim 9, wherein the data unit separator separates the PDU from the burst according to payload size information contained in a MAC header when the header of the PDU is a general MAC header.

17. The apparatus according to claim 9, wherein the data unit separator determines re-concatenated data to be a header of the PDU when the header of the PDU is a bandwidth request header.

18. A method for generating and transmitting a burst using concatenated data units of a transmission end, comprising the step of:
designating a starting point of each data unit to begin at a specific position corresponding to an integer multiple of a predetermined size in the burst when at least two data units are concatenated to each other.

19. The method according to claim 18, further comprising the steps of:
separating the data unit from the burst according to one of a minimum data unit size and an integer multiple of the minimum data unit size; and
configuring the separated data unit.

20. The method according to claim 18, further comprising the step of:
if the data unit is unable to be one of packed and fragmented, performing a mapping process in to begin each data unit at an integer multiple position of a predetermined size in a burst to be physically transmitted.

21. The method according to claim 18, further comprising the step of:
if a gap is generated between two concatenated data units, padding the gap with a specific value.

22. The method according to claim 18, wherein the data unit is a header.

23. The method according to claim 18, wherein the data unit is a PDU (Protocol Data Unit).

24. The method according to claim 18, wherein the data unit includes a header and a PDU (Protocol Data Unit).

25. An apparatus for generating and transmitting a burst using concatenated data units of a transmission end, comprising a data unit mapper for designating a starting point of each data unit to begin at a specific position corresponding to an integer multiple of a predetermined size in the burst when at least two data units are concatenated to each other.

26. The apparatus according to claim 25, wherein the data unit mapper separates the data unit from the burst according to one of a minimum data unit size and an integer multiple of the minimum data unit size, and configures the separated data unit.

27. The apparatus according to claim 18, wherein the data unit mapper, if the data unit is unable to be one of packed and fragmented, performs a mapping process to begin each data unit at an integer multiple position of a predetermined size in a burst to be physically transmitted.

28. The apparatus according to claim 25, wherein the data unit mapper pads a gap with a specific value when the gap is generated between two concatenated data units.

29. The apparatus according to claim 25, wherein the data unit is a MAC (Media Access Control) header.

30. The apparatus according to claim 25, wherein the data unit is a MAC (Media Access Control) PDU (Protocol Data Unit).

31. The apparatus according to claim 25, wherein the data unit includes a MAC (Media Access Control) header and a MAC PDU (Protocol Data Unit).

32. The apparatus according to claim 25, further comprising a data unit composer for constructing data to be transmitted in a form of data units

33. A transmission and reception data burst structure for use in a wireless communication system, comprising a plurality of data units included in the data burst, in which a starting point of each data unit begins at an integer multiple position of a predetermined size in the burst.

34. The data burst structure according to claim 33, wherein the data burst is configured by padding a gap formed between two concatenated data units with a specific value.

35. A method for receiving a burst having a plurality of data units, comprising the steps of:
if each of the plurality of data units includes at least one MAC (Media Access Control) header, determining if a first MAC header is effective;
if the first MAC header is not effective, searching for a next MAC header of a predetermined size;
determining if the next MAC header is effective; and
if it is determined that the next MAC header is effective, processing next data according to a type of header.

36. The method according to claim 35, further comprising the steps of:
demodulating a PDU (Protocol Data Unit), if the PDU is effective for the next data; and
discarding the PDU, if the PDU is not effective.

37. The method according to claim 35, wherein the predetermined size corresponds to an integer multiple of 8 bits.
